(19) United States
(12) Patent Application Publication
(10) Pub. No.: US 2014/0010732 A1
(43) Pub. Date: Jan. 9, 2014

(54) Pipette for Operating a Syringe

(71) Applicant: Eppendorf AG, Hamburg (DE)

(72) Inventors: Herbert Belgardt, Hamburg (DE); Peter Molitor, Hamburg (DE); Burkhardt Reichmuth, Hamburg (DE); Jörg Sattler, Hamburg (DE); Jens Wilmer, Ahrensburg (DE)

(73) Assignee: Eppendorf AG, Hamburg (DE)

(21) Appl. No.: 13/919,405

(22) Filed: Jun. 17, 2013

Related U.S. Application Data
(60) Provisional application No. 61/661,018, filed on Jun. 18, 2012.

(30) Foreign Application Priority Data
Jun. 18, 2012 (DE) 10 2012 011 639.0

(51) Int. Cl. B01L 3/02

(52) U.S. Cl. CPC B01L 3/0217
USPC 422/501

(57) ABSTRACT

A pipette for actuating a syringe, with a bar-shaped housing, a first fixture with a first opening at the lower end of the housing for putting in a first fastening portion on the upper edge of a cylinder of the syringe, a fixture body with a second fixture and a second opening on the lower end of the housing, for putting in a second fastening portion on a piston of the syringe, an actuating element, a tooth bar connected to the fixture with a tooth in the housing, a pawl, pivotally mounted on the actuating element in the housing, an adjusting element for adjusting the step size of the steps, a covering, movably arranged on the tooth bar at the side of the pawl, and a coupling element arranged on the covering.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention relates to a pipette for operating a syringe.

The pipettes for operating a syringe discussed here serve for discharging liquids taken up into the syringe in several steps. They are also called dispensers or repeater pipettes. At the lower end of a bar-shaped housing, these pipettes have a fixture for a flange of a cylinder of the syringe, and in the housing a displaceable fixture body with a piston fixture for the upper end portion of a piston rod of a piston of the syringe. The syringe can be inserted with the flange and the end portion of the piston rod through axially oriented openings of the fixtures. The flange and the end portion are held in the fixtures by means for detachably holding, which are for instance configured as spring-tensioned gripping levers. Further, the pipette has means for displacing the fixture body, which permit to draw the piston partially out of the cylinder in order to aspirate liquid into the syringe, and to push it stepwise into the cylinder for stepwise discharge of liquid.

The documents DE 2926691 C2 and U.S. Pat. No. 4,406,170 A, the entire contents of which is incorporated herein by reference, describe means for displacing the fixture body in the housing. These comprise a draw-up lever, connected to the fixture body and projecting out of the housing through a straight slit, for aspirating liquid into the syringe by moving the fixture body away from the fixture. They further comprise a tooth bar pawl device for stepwise piston forward movement by a reciprocating metering lever. A pivotal pawl is bearing mounted on the metering lever. The tooth bar is connected to the fixture body and arranged in the pivot region of the pawl. An adjustably movable covering more or less covers up the tooth row on the tooth bar, in order to limit the engagement of the pawl into the tooth bar when the metering lever is swung. The movable covering can be displaced by means of a turning knob which is arranged on the pipette housing. The turning knob is made with an eccentric guide curve, into which a guide pin of the movable covering engages. Further, the tooth bar is designed with a projecting tappet, by which the covering can be moved away from the tooth bar when the piston is in an advanced position, so that it prevents the pawl from engaging with those teeth of the tooth bar that are not covered. Through this residual stroke lock, it is prevented that a residual amount is discharged from the syringe, which is smaller than the metering amount which is to be discharged (the dispensing volume) in each metering step.

Further developments of the means for detachably holding the syringe are described in the documents EP 0 656 229 B1 and U.S. Pat. No. 5,620,660 A, the entire contents of which is incorporated herein by reference. The documents EP 1 724 020 B1 and U.S. Pat. No. 7,731,908 B2, the entire contents of which is incorporated herein by reference, describe a further development of the holding devices which permits to detach the syringe from the pipette using only one hand.

The documents EP 0 657 216 B1 and U.S. Pat. No. 5,620,661 A, the entire contents of which is incorporated herein by reference, describe such a pipette with a sensor for gauging protrusions and deepenings on the syringe flange of the syringes, and correspondingly shaped syringes. The sensor serves to determine the size of the utilized syringe. On the basis of the set step size, an electronics assembly determines the amount of liquid that is discharged in each discharging step. This is indicated on a display.

Further developments of the means for displacing the fixture body are described in the documents DE 44 37 716 C2, EP 0 679 439 B1 and U.S. Pat. No. 5,591,408 A, the entire contents of which is incorporated herein by reference. According to EP 0 679 439 B1 and U.S. Pat. No. 5,591,408 A, the entire contents of which is incorporated herein by reference, a repeater pipette has a constant step equipment, which fixes the size of the first step for moving the fixture body for the actuating portion of the syringe piston towards the cylinder fixture for the syringe cylinder to a constant value, which is independent of the setting of the subsequent step sizes. Through this constant reverse stroke when the fixture body is moved back to the cylinder fixture after drawing up liquid, a clearance between pipette and syringe is overcome which would impair the metering accuracy.

In the manual pipette “Multipipette® Plus” of the company Eppendorf AG, the applicant of this application, the covering comprises an elongate sleeve made of plastics, in which a threaded bar is movably arranged. A metal sleeve is glued into the lower end of the plastics sleeve. The metal sleeve projects from the lower end of the plastics sleeve and has an incident edge at the bottom side, below of which the thread for engagement of the pawl is exposed. In a metering step, the pawl slips at first over the metal sleeve which withholds the pawl from engagement into the thread of the threaded bar. As soon as the pawl passes the incident edge in the metering step, it falls into the thread. For this purpose, it is pressed against the metal sleeve and the thread by means of a spring. Due to manufacturing tolerances, it may happen that the pawl does not engage exactly into the root of the thread below the incident edge, but instead it hits a flank or an apex of the thread. When the pawl hits a flank or an apex of the thread which is located above the root of the thread, the metering lever has to be swung somewhat more downward, until the pawl engages into the root of the thread and thus thrusts the threaded bar and with it the piston of the syringe forward. Through this, a metering error occurs, because too little liquid is delivered. In case that the pawl hits a flank or the apex of the thread which is arranged below the root of the thread, a too small part of the swinging movement of the metering lever is also used for the displacement of the threaded bar, and thus of the piston. Even in this case, too little liquid is delivered. It may even happen that the pawl slips off from the flank or the apex of the thread and falls into the root of the thread more downwardly, or slips several times over the thread, so that an increased metering error occurs or no liquid is delivered at all. The metering error can be overcome by adjusting the threaded bar. For this purpose, the threaded bar is screwed into an adjusting thread in the fixture body for the upper end of the piston rod, and is provided with a transversal bore. By means of a pin which is inserted into the transversal bore, the threaded bar can be screwed into another axial position with respect to the fixture body. Through this, the position of the threaded bar when the pawl falls in is changed. This adjustment on the completely assembled pipette is sumptuous. If the metal sleeve is glued into the plastics sleeve too deeply, too much liquid is delivered and the indicated number of metering steps cannot be attained. This error must be repaired by replacing the covering.

In the manual pipette “Handy-Step-S” of the company Brand, the setting of the volume of liquid that is to be metered in each step is also done by means of a turning knob. Moreover, the engagement of the pawl into the tooth bar can be adjusted by means of the turning knob. For this purpose, the turning knob has two turning knob parts, whose angular position with respect to each other can be adjusted via a gear mechanism. One turning knob part has marks for setting the metering volume. The other turning knob part has the guide curve into which the pin engages which projects from the covering. By rotating the turning knob, the covering is displaced along the tooth bar. By adjusting the angular position of the two turning knob parts, the position of the incident edge can be set such that the pawl falls into a valley of the toothing. In this pipette, the high constructional expense is disadvantageous, as well as the high expense for the adjustment which must be done on the assembled pipette.

### BRIEF DESCRIPTION OF THE INVENTION

Starting from this, the present invention is based on a goal to provide a pipette wherein optimum falling of the pawl into the toothing can be achieved with reduced expense.

The pipette of the present invention for actuating a syringe has
a bar-shaped housing,
a first fixture with a first opening at the lower end of the housing for putting in a first fastening portion on the upper edge of a cylinder of the syringe,
a fixture body with a second fixture and a second opening on the lower end of the housing, for putting in a second fastening portion on a piston of the syringe,
first means for detachably holding the first fastening portion in the first fixture,
second means for detachably holding the second fastening portion in the second fixture,
first means for displacing the fixture body in the housing away from the first fixture,
second means for displacing the fixture body towards the first fixture in steps with a step size corresponding to the liquid volumes to be ejected by the syringe in the steps,
an actuating element for performing single steps, which can be actuated from the outside of the housing
a tooth bar connected to the fixture with a toothing in the housing,
a pawl, pivotally mounted on the actuating element in the housing, which comes into engagement with the toothing of the tooth bar when the actuating element is displaced downward and takes the tooth bar along, and comes out of engagement with the toothing when the actuating element is displaced upward,
an adjusting element, adjustable from the outside of the housing, for adjusting the step size of the steps,
a covering, movably arranged on the tooth bar at the side of the pawl and having a withholding surface facing the pawl, for withholding the pawl from engagement into the toothing, and having an incident edge at the lower end, below of which the toothing is exposed for the engagement by the pawl,
a coupling element arranged on the covering, which is coupled to the adjusting element in order to transfer a setting of the adjusting element to the covering,
wherein the covering comprises a first covering part on which the coupling element is arranged, and a second covering part on which the incident edge is formed, whose relative position to each other in the longitudinal direction of the tooth bar is adjustable, and
means for positioning arranged on the covering, which fix the first and the second covering part in an adjusted position relative to each other.

The pipette of the present invention is based on the finding that a non-optimal falling of the pawl into the toothing of the tooth bar is decisively caused by the production tolerance of the covering which is arranged on the tooth bar and limits the engagement of the pawl into the toothing. Decisive for the error is the distance of the incident edge from the pin or another coupling element, via which the covering is connected to the dial. According to the present invention, the covering has therefore a first covering part on which the pin or another coupling element for coupling to a dial or another adjusting element is arranged, and a second covering part which comprises the incident edge. The first and the second covering part can be dislocated with respect to each other in the longitudinal direction of the tooth bar. Through this, it is possible to adjust the distance of the incident edge from the coupling element. Moreover, the covering comprises means for positioning which permit to fix the first and the second covering part in a certain adjustment with respect to each other. Thus, the means for positioning make sure that the distance of the incident edge from the coupling element is not changed without intent. The adjustment of the first and the second covering parts with respect to each other and the fixation of the first and the second covering parts in the adjusted position may in principle occur before the integration of the covering into the pipette. In doing so, it is sufficient to adjust the covering such that a given distance between incident edge and coupling element is maintained. This adjustment of the covering can be made easily by hand and is automatable. After the integration of an adjusted covering into a pipette, an optimum engagement of the pawl into the toothing is in principle given, so that metering errors can be avoided. If a metering error occurs in spite of this, it can be corrected easily even when the covering is integrated into the pipette, namely by actuating the means for positioning and dislocating the first and the second covering parts with respect to each other. This holds also in case that a metering error occurs due to wear or repair in the operation. Thus, the pipette of the present invention permits to avoid metering errors with relative little effort.

The fixture body is dislocated between an upper position and a lower position. The upper position is fixed by an upper stop at a fixed position in the housing, against which the first means for displacing the fixture body or the fixture itself hit at the end of the displacement away from the fixture in the housing. The lower position is fixed by a lower stop on a fixed position in the housing, against which the second means for displacing the fixture body or the fixture body itself hit at the end of the displacement of the fixture body towards the first fixture. The adjustment of the covering takes place preferably in the upper position of the fixture body, which is the starting position of the fixture body immediately before dispensing.

According to one embodiment, the first covering part is arranged on the tooth bar, and the second covering part is held on the first covering part. The second covering part is preferably arranged on that side of the first covering part which faces the pawl. The first covering part comprises the coupling element, and the second covering part the incident edge. In this embodiment, the first covering part is the carrier for the second covering part. By displacing the second covering part on the first covering part, the distance between incident edge and coupling element can be adjusted.

According to an alternative embodiment, the second covering part is arranged on the tooth bar, and the first covering part is held on the second covering part. The first covering part is preferably arranged on that side of the second covering part which faces the pawl. The second covering part comprises the incident edge, and the first covering part the coupling element. By displacing the first covering part on the second covering part, the distance between incident edge and coupling element can be adjusted.

According to a further embodiment, the covering has means for axially guiding the second covering part with respect to the first covering part, and first and second covering part are guided parallel to the tooth bar by the means for axially guiding. The adjustment of the first and the second covering part with respect to each other is simplified through this.

According to a further embodiment, the means for axially guiding comprise guiding structures of the first covering part extending over the second covering part at the edge thereof. In the assembly, the second covering part can be thrust under the guiding structures, or it can be snapped in below the same. Thereafter, the second covering part is secured on the first covering part. Through this, the assembly is facilitated, and at the same time the axial guiding parallel to the tooth bar is achieved. The guiding structures are preferably realised as guide hooks.

According to a further embodiment, the second covering part is a thin-walled piece of metal, preferably a plate or a metal sleeve. The pawl can be guided in a small distance from the tooth bar on the withholding surface of the thin-walled metal piece, so that it falls directly into the toothing after passing the incident edge.

According to one embodiment, the first covering part is a hollow body guided on the tooth bar, and/or the second covering part is stripe-shaped. The first covering part forms a stable carrier for the second covering part. The hollow body can be produced from plastics with small error tolerances, by injection moulding in particular. The first covering part is preferably made in a box-like shape with a channel at one side which accommodates the tooth bar. The stripe-shaped second covering part can be made from one single metal plate. When the second covering part is made of metal, the distance between pawl and toothing and the friction between pawl and covering can be made particularly small. According to a preferred embodiment, the second covering part is spring elastic. A spring elastic realisation of the second covering part favours the implementation of a residual stroke lock, which prevents the delivery of a residual amount of liquid from the syringe in case that it is smaller than the set metering amount.

According to a further embodiment, the tooth bar comprises a projecting cam on the side facing the covering, the first covering part has a longitudinal slot out of which the cam exits when the fixture body is displaced towards the first fixture, the second covering part has an angular deflection and a spring tongue connected thereto which the cam hits when the displacement of the fixture body towards the first fixture is ended, whereby the spring tongue is deflected and the pawl is withheld from further engagement into the toothing of the tooth bar by the spring tongue. Through this embodiment, a residual stroke lock is implemented after the last dispensing step when a syringe is emptied. The second covering part is preferably realised as a thin-walled metal piece as a whole, preferably of plate. This is advantageous for the realisation of the angular deflection and of the spring tongue as integral parts of the metal piece, and for withholding the pawl in an only small distance from the toothing. Dimensional tolerances of the first covering part and the second covering part, and tolerances due the assembly of the first and the second covering part can be compensated in a favourable way through the adjustability of the relative position of first and the second covering part according to the present invention.

According to a further embodiment, the means for positioning comprise means for adjusting the position of the second covering part relative to the first covering part in the longitudinal direction of the tooth bar. In this embodiment, the means for positioning can be utilized for the adjustment of the second covering part relative to the first covering part. Through this, the first and second covering parts can be adjusted with a particularly accurate match.

According to a further embodiment, the means for positioning comprise an eccentric part with a shaft, an eccentric on the shaft and a tool application arrangement at one end of the shaft, wherein the shaft is bearing mounted at one end in a bearing bore of the first covering part or of the second covering part, and the eccentric engages into an eccentric receptacle of the second covering part or of the first covering part, so that the second covering part can be moved relative to the first covering part via the eccentric by rotating the shaft. This embodiment permits the adjustment of the relative position of the first and the second covering part by simply turning the shaft. The shaft can be turned by applying a tool on the tool application arrangement and then turning the tool. In the adjusted position, the first and the second covering part are secured by the means for positioning. Preferably, the shaft has a friction with respect to the first or the second covering part, which prevents the shaft from rotating without intent.

According to a further embodiment, a disc is arranged at one end of the shaft, which bears against the outer side of the second covering part or of the first covering part, and/or the shaft has a catch projection at one end which grips behind a bore edge of the bearing bore of the first covering part or of the second covering part. The catch projection can be turned behind the edge, or it can be locked in place behind it. By these embodiments, the shaft is prevented from slipping out of the bearing bore and the eccentric receptacle. Disc and catch projection are preferably arranged on different ends of the shaft.

According to another embodiment, the means for position comprise a first holder on the first covering part, and a second holder on the second covering part, a bore parallel to the tooth bar or a further adjusting thread parallel to the tooth bar in the first holder and a further adjusting thread parallel to the tooth bar or a bore parallel to the tooth bar in the second holder, a further adjusting screw screwed into the bore of the first or second holder and into the further adjusting thread of the second or the first holder, and a further spring element between first covering part and second covering part which acts against the screwing direction of the further adjusting screw. The further spring element is preferably a helical spring, which is guided on the further adjusting screw and is supported at one end on the first holder, and at the other end on the second holder. By screwing in the further adjusting screw against the action of the further spring element, the covering parts can be displaced relative to each other in one direction, and by screwing out the further adjusting screw and by the action of the further spring element, they can be displaced relative to each other in the other direction.

According to a further embodiment, the means for positioning permit to adjust the position of the second covering part with respect to the first covering part in an adjustment range which corresponds to the distance of two valleys on different sides of a tooth of the toothing. By doing so, it is possible to adjust the distance of the incident edge from the coupling element exactly such that the pawl falls optimally into the toothing when it passes the incident edge.

In a preferred embodiment, the means for positioning permit to adjust the position of the second covering part with respect to the first covering part in an adjustment range which is +/−0.25 mm. This adjustment range is matched to a tooth bar with a distance from tooth to tooth, or from valley to valley, respectively, of 0.5 mm. This division of the tooth bar has proven to be advantageous for setting metering amounts which are often needed in the laboratory. The adjustment range permits to adjust the first and second covering parts always such that the pawl falls optimally into the toothing.

According to another embodiment, the means for positioning are means for fixing the first and second covering parts on each other which act on the first and second covering parts. These means are for example means for clamping fast the first covering part on the second covering part. They can for instance be formed by a screw, which is screwed into a threaded bore of the first covering part and engages into a long hole of the second covering part which is directed parallel to the tooth bar. When the screw is released, the relative position of first and second covering part can be adjusted. By tightening the screw, the first and second covering parts can be tensed together, so that they maintain the adjusted relative position. Several screw arrangements of the mentioned kind may form the axial guiding of the two covering parts in the longitudinal direction of the tooth bar at the same time.

According to a further embodiment, the coupling element is a pin protruding from the first covering part and the adjusting element comprises a guide curve at the bottom side into which the pin engages, so that the guide curve displaces the pin in the axial direction of the tooth bar when the adjusting element is shifted. According to a preferred embodiment, the adjusting element is a dial. According to a further embodiment, the guide curve is helical.

According to a further embodiment, the means for positioning are arranged such on the covering that they are not covered up by the adjusting element in at least one position of the adjusting element. This favours adjustment of the relative position of the first and second covering parts even in the assembled state of the pipette. The case given, the adjusting element must be set only into a position in which the means for adjusting are not covered up by the adjusting element, but are accessible through a housing opening or after taking away a part of the housing.

According to a further embodiment, the means for positioning are arranged at the upper end of the covering. This embodiment is particularly advantageous for an adjustment of the relative position of first and second covering part when the pipette is assembled.

According to a preferred embodiment, the pawl has several pawl teeth, which engage into the toothing of the tooth bar after passing the incident edge. But the invention incorporates also embodiments where the pawl has only one single pawl tooth.

According to a further embodiment, the cam projects through a slot of the tooth bar at the side of the withholding element and has an axial bore, an adjusting screw is screwed passing through the bore into an adjusting thread at the upper end of the tooth bar, and a spring element is arranged between the upper end of the tooth bar and the cam. This embodiment permits adjustment of the axial position of the cam on the tooth bar. Through this, the position of the tooth bar is influenced in which the cam hits the second covering part and the residual stroke lock becomes active.

According to a further embodiment, the first covering part is made of plastics and/or the second covering part of a sheet of metal. The first covering part is preferably made by injection moulding, and/or the second covering part by etching or punching and in case by bending a plate, or other manufacturing methods.

The means for detachably holding the first fastening portion in the first fixture, and the second fastening portion in the second fixture, are preferably made such like described in the documents EP 0 656 229 B1 and U.S. Pat. No. 5,620,660 A or in EP 1 724 120 B1 and U.S. Pat. No. 7,731,908 B2, whose content is herewith incorporated into the present application by reference.

The first means for displacing the fixture body in the housing are preferably realized as draw-up levers, like described in the documents DE 29 26 691 C2 and U.S. Pat. No. 4,406,170A and in the documents mentioned in the above paragraph, whose content is herewith incorporated into the present application by reference.

According to one embodiment, the pipette has a sensor for gauging protrusions and indentations on a syringe flange of the syringes, like described in EP 0 657 216 B1 and U.S. Pat. No. 5,620,661A, whose content is herewith incorporated into the present application by reference.

In the present application, with the term “tooth bar” is meant a tooth bar in the proper sense, i.e. a bar with a series of teeth arranged thereon, but also a threaded bar, i.e. a bar with at least one thread arranged thereon. The pipette of the present invention is preferably provided with a tooth bar in the proper sense.

In the present application, the indications “up” and “down”, “high” and “deep” as well as terms derived from this refer to the alignment of the pipette wherein the rod-shaped housing is aligned vertically, and he fixture for the syringe is disposed at the bottom side.

### BRIEF DESCRIPTION OF THE SEVERAL VIEWS OF THE DRAWINGS

The invention will be explained in more detail below by way of the attached drawings of an example of its realisation. In the drawings show:

FIG. 1 a pipette of the present invention with syringe held therein, in a perspective view from the side;

FIG. 2 the same pipette in a longitudinal section;

FIG. 3 the same pipette when the front half of the housing is removed, in a perspective view skew from the front and from the side;

FIG. 4 an upper frame part of the same pipette, with component parts arranged therein, at removed housing in an enlarged perspective view;

FIG. 5 the same arrangement in a longitudinal section;

FIG. 6 tooth bar with actuating element, pawl and covering of the same pipette, in a more enlarged perspective view;

FIG. 7 covering of the same pipette in a further perspective view;

FIG. 8 enlarged detail of the same covering when the eccentric part is removed, in a further perspective view;

FIG. 9 the covering in a further perspective view;

FIG. 10 the covering in a perspective exploded view;

FIG. 11 the eccentric part in a more enlarged perspective view;

FIG. 12 the eccentric part in a view from the opposite side;

FIG. 13 the covering in an adjusting position, with the incident edge in the lowermost position in a front view;

FIG. 14 the covering in an adjusting position, with the incident edge in the central position in a front view;

FIG. 15 the covering in an adjusting position, with the incident edge in the uppermost position in a side view;

FIG. 16 the dial in a view from the bottom side;

FIG. 17 the pipette when the actuating element is being actuated, before the engagement of the pawl into the toothing, in a longitudinal section;

FIG. 18 the pipette in the same situation, in an enlarged detail view;

FIG. 19 the pipette at optimum engagement of the pawl into the toothing in a longitudinal section;

FIG. 20 the pipette in the same situation, in an enlarged detail view;

FIG. 21 the pipette with unfavourable engagement of the pawl into the toothing, in a longitudinal section;

FIG. 22 the pipette in the same situation, in an enlarged detail view.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

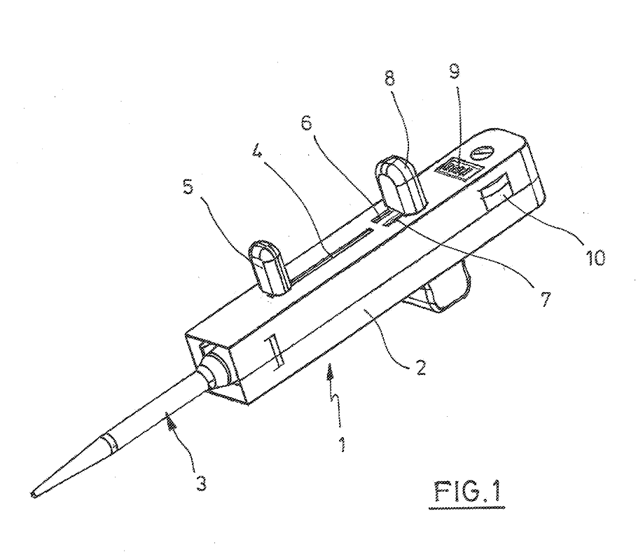

According to FIG. 1, a pipette 1 has a bar-shaped housing 2, in which a syringe 3 is held at the downside. From a side wall of the housing 2, a draw-up lever 5 projects from the housing 2 above a straight slit 4. An actuation button 8 of a tooth bar—pawl control equipment projects from the same side wall of the housing 2 above two further slits 6, 7. Above it, indicating equipment in the form of a LCD display 9 is countersunk into the same side wall of the housing 2. Segments of a dial 10 project from openings in the neighbouring side wall.

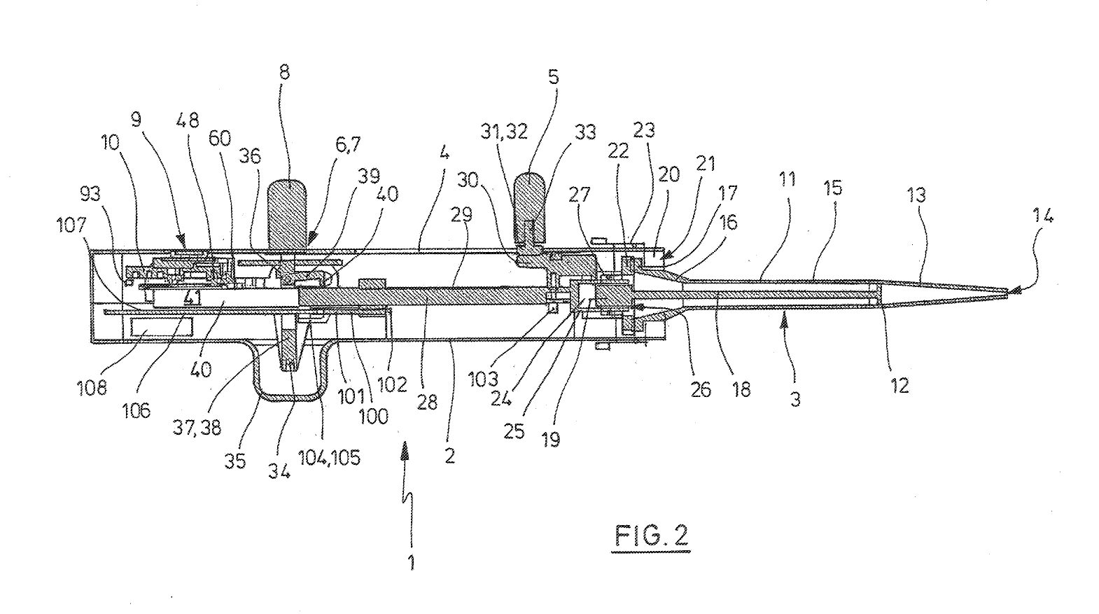

According to FIG. 2, the syringe 3 has a cylinder 11 and a piston 12 movably arranged therein. The cylinder 11 has a conical portion 13 with a hole 14 for the passage of liquids at the bottom, and above it a cylindrical portion 15 in which the piston 12 can be displaced. At the top, the cylinder 11 has a first fastening portion 16 with a circumferential flange 17. A piston rod 18 projects towards the upside from the piston 12 and has a second fastening portion 19 with several circumferential bulges.

The syringe 3 is arranged with its flange 17 in a first fixture 20 at the lower end of the housing 2, which has an axially directed first opening 21 for insertion and withdrawing of the syringe 3 at the lower end of the housing 2. With its topside, the syringe 3 pushes against a pressure-sensitive ring sensor 22, which gauges projections on the upper edge of the flange 17. The code given on the flange 17 indicates the size of the respective syringe 3. The flange 17 is kept in the housing 2 in this position by way of first means for detachably holding in the form of first gripping levers 23.

The second fastening portion 19 of the piston 12 is disposed in a second fixture 24 in a hollow-cylindrical fixture body 25. The latter has a second axially oriented opening 26 for inserting the second fastening portion 19. The second fastening portion 19 is held by way of second means for detachably holding in the form of second gripping levers 27, which engage between the bulges of the second fastening portion 19 or clamp it in.

The fixture body 25 is fixedly connected to a tooth bar 28 with a toothing 29, which extends below the slit 4 in the longitudinal direction of the housing 2.

A draw-up lever mount 30 is fixed on the fixture body 25 and on a lower part of the tooth bar 28.

Further, there is a draw-up lever carrier 31, which bears against the lower side of the edges of the slit 4 with a sliding board 32. The draw-up lever carrier 31 has an upward-projecting post 33 which grips through the slit 4. Outside of the housing 2, the draw-up lever 5 is fixed on the post 33.

At the end of the displacement of the fixture body 25 towards the first fixture 20, the board 32 hits the lower edge of the slit 4, by which a lower stop is given.

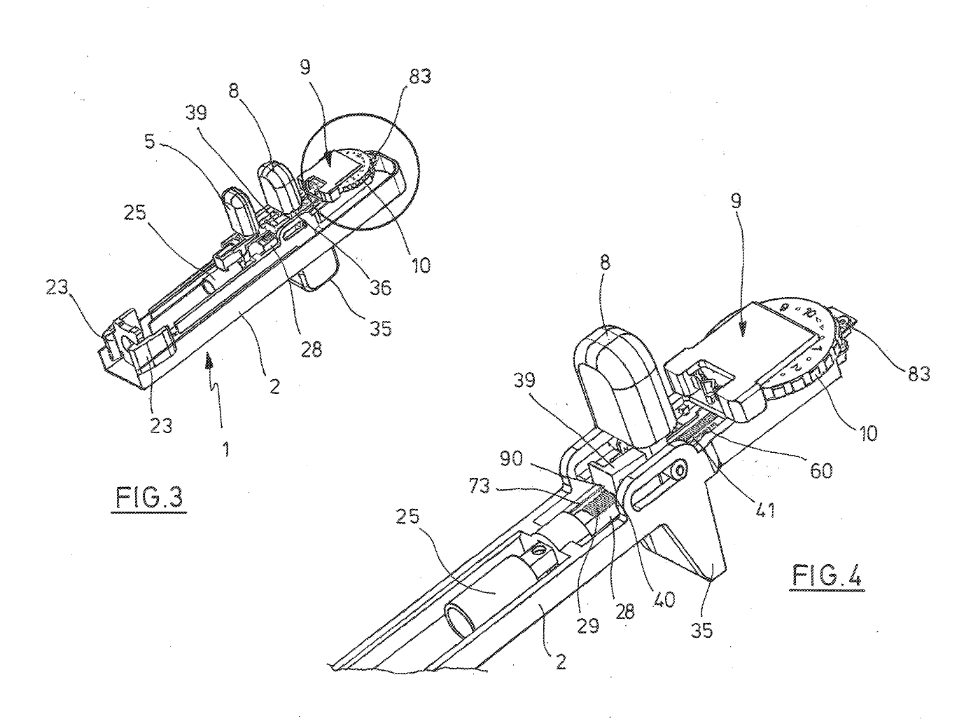

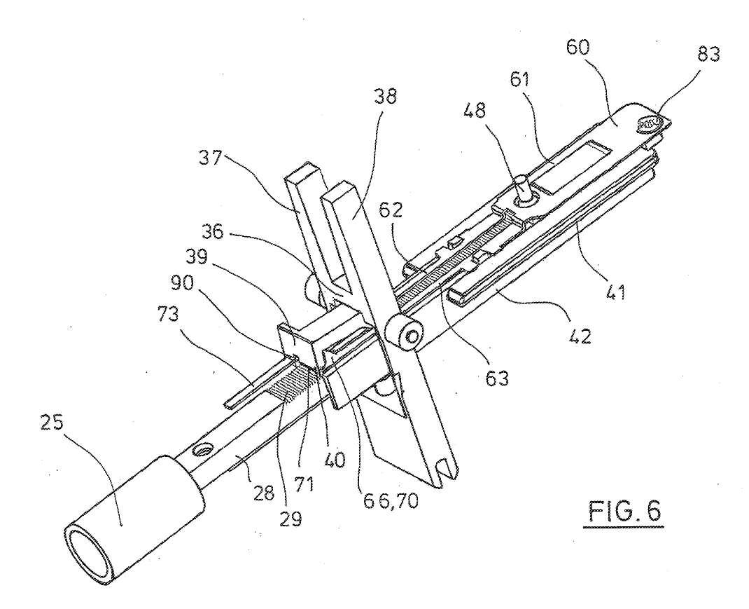

In the upper half of the housing 2, an actuating element in the form of a metering lever 36 is pivotally mounted in a hinge bearing 34 in a bulge 35 of the side wall of the housing 2 opposite to the slit 4. According to FIGS. 3 to 6, the metering lever 36 has two spaced apart legs 37, 38, which stand out of the two slits 6, 7 on the opposite side wall of the housing 2. The actuation button 8 is fixed there on the projecting ends of the legs 37, 38.

At the end of the upward directed displacement of the fixture body 25 away from the first fixture 20, the draw-up lever carrier 31 hits a bearing body which is fixedly arranged in the housing 2, in which the hinge bearing 34 for the metering lever 36 is formed. The upper stop for the displacement of the fixture body 25 is given through this.

Between the two legs 37, 38 of the metering lever 36, a pawl 39 is pivotally mounted. The pawl 39 is arranged above the toothing 29 of the tooth bar 28 with several pawl teeth 40 (three in the example). The metering lever 36 is pressed into the position of FIG. 2 by a spring device. Against the action of the spring device, the metering lever 36 can be swung towards the downside by actuating the actuation button 8. The pawl 39 is pushed towards the toothing 29 of the tooth bar 28 by a further spring device. The tooth bar 28 is thrust downward through this.

A movable covering 41 is arranged between pawl 39 and tooth bar 28. The covering 41 can be dislocated by turning the dial 10 which projects laterally out of the housing 2, so that it covers the toothing 29 of the tooth bar 28 more or less. In the actuation of the actuation button 8, the pawl is at first pressed against the covering 41, and below the latter it falls into the toothing 29. For this reason, the amount of displacement of the tooth bar 28 depends on the position of the covering 41 with respect to the toothing 29 when the metering lever 36 is swung downward.

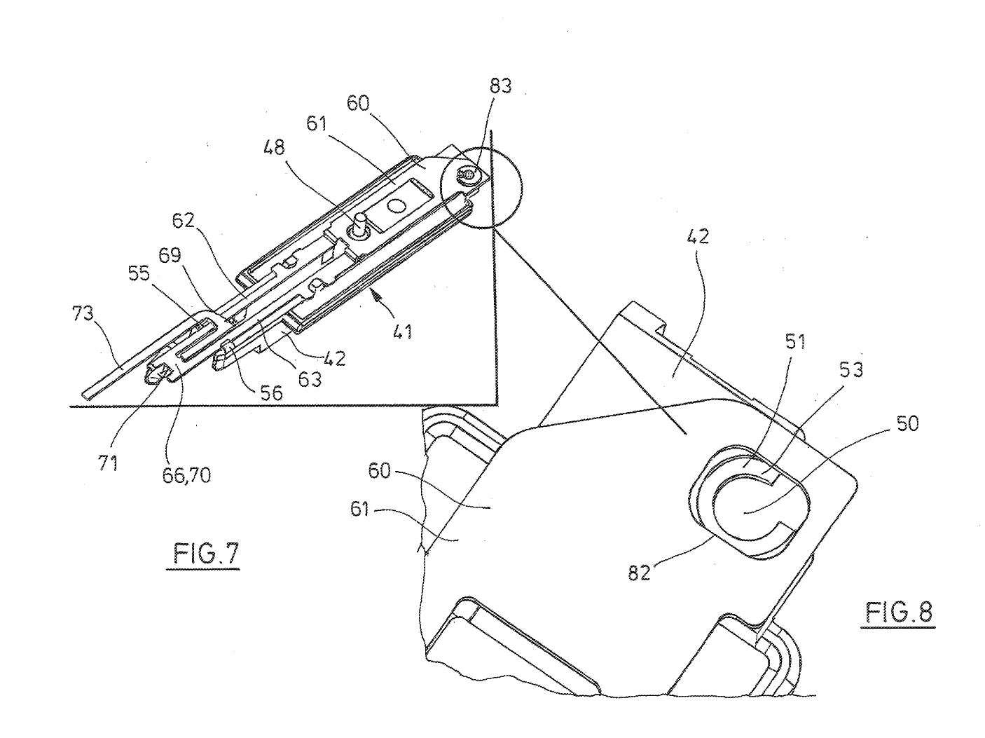

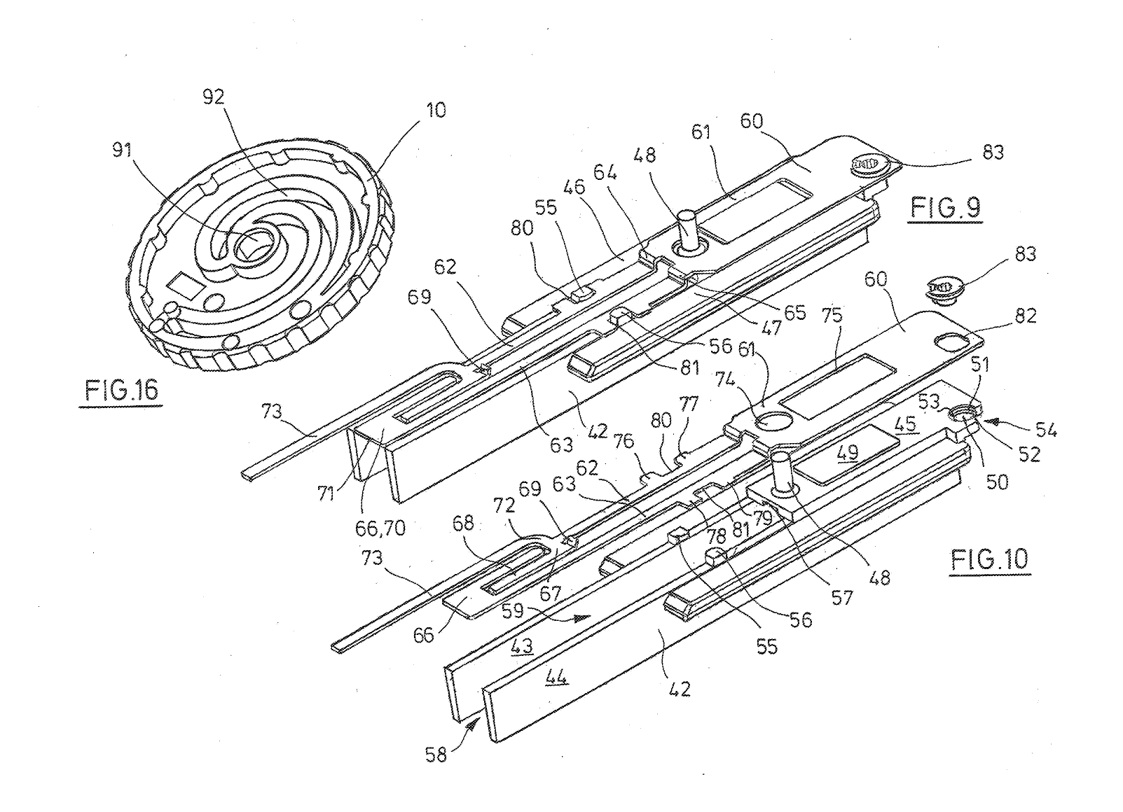

According to FIGS. 7 to 10, the covering 41 comprises a first covering part 42 in the form of an elongate hollow body. The first covering part 42 has two parallel, stripe-shaped side parts 43, 44. These are bridged on the front edges in the upper area by a board-shaped cantilever 45. Stripe-shaped wing parts 46, 47 project vertically from the outer sides of the side parts 46, 47.

Near to the lower end of the cantilever 45, a coupling element in the form of a pin 48 projects vertically from it. Moreover, a board shaped groove nut 49 exists on the front side of the cantilever 45.

Finally, the cantilever has a bearing bore 50 in the vicinity of its upper end, which extends vertically across the cantilever 45. The bearing bore 50 is formed in a portion of the cantilever 45 which projects beyond the side part 44. The bearing bore 50 comprises a front deepening 51 at the front side, and a rear deepening 52 at the bottom side. There between, a circular ring disc shaped bore edge 53 circulates in the bearing bore 50.

The cantilever 45 has a first recess 54 at an upper end, and the bearing bore 50 is opened towards the recess 54.

Guide hooks 55, 56 which face each other project from the front edge of the side parts 43, 44.

On the rear side of the cantilever 45, there is a longitudinal groove 57, which extends in the longitudinal direction of the first covering part and is opened towards a channel 58 in the distance area between the side parts 43, 44. A longitudinal slot 59 exists below the cantilever 45 between the front edges of the side parts 43, 44.

The first covering part 42 is preferably injection moulded in one piece from plastics.

Further, the covering 41 comprises a second covering part 60, which is essentially stripe-shaped. The second covering part 60 has a board-shaped head portion 61 on the top, and at the bottom two parallel stripe shaped centre portions 62, 63, which are connected to the head portion 61 via reverse angular deflections 64, 65.

The centre portion 62 has a U-shaped foot portion 66 at its lower end. The foot portion 66 is connected to the centre portion 62 on one leg, and the other leg is directed towards the centre portion 63. At its lower end, the centre portion 63 is connected via a first connection portion 67 to a central stripe portion 68, which has a projecting angular deflection 69 at its upper end. The central stripe portion 68 is arranged between the legs of the U-shaped foot portion 66.

On the front side of the foot portion 66 there is a withholding surface 70, and the lower edge of the foot portion 66 is an incident edge 71. The pawl 39 is dislocated over the withholding surface 70, and after passing the incident edge 71 it engages into the toothing 29.

Further, the centre portion 63 is connected at the lower end via a second connection portion 72 to a spring tongue 73, which is arranged adjacent to the U-shaped foot portion 66 and extends downward in parallel to the centre portions 62, 63.

The head portion 61 has a big hole 74, which receives the pin 48 with clearance. Further, the head portion 61 has a big rectangular punching 75, which receives the groove nut 49 with axial clearance.

The two centre portions 62, 63 have free spaces 80, 81 on the opposite edges between projecting tongues 76 to 79. The guide hooks 55, 56 engage with axial clearance into the free spaces 80, 81 and grip over the centre portions 62, 63 at the edge sides.

Thus, the second covering part 60 is held on the first covering part 42, guided in the longitudinal direction on the first covering part 42, and can be displaced with respect to the first covering part 42 in the longitudinal direction.

Moreover, the head portion 61 has an eccentric receptacle 82 on an upper corner. The eccentric receptacle 82 is approximately rectangular, the corners being rounded. The eccentric receptacle 82 is arranged above the bearing bore 50, wherein the shorter side of the eccentric receptacle 82 is arranged in the longitudinal direction of the first covering part 42, and the longer side vertically thereto.

The second covering part 60 is for instance made of a plate of spring steel in one piece by punching or bending.

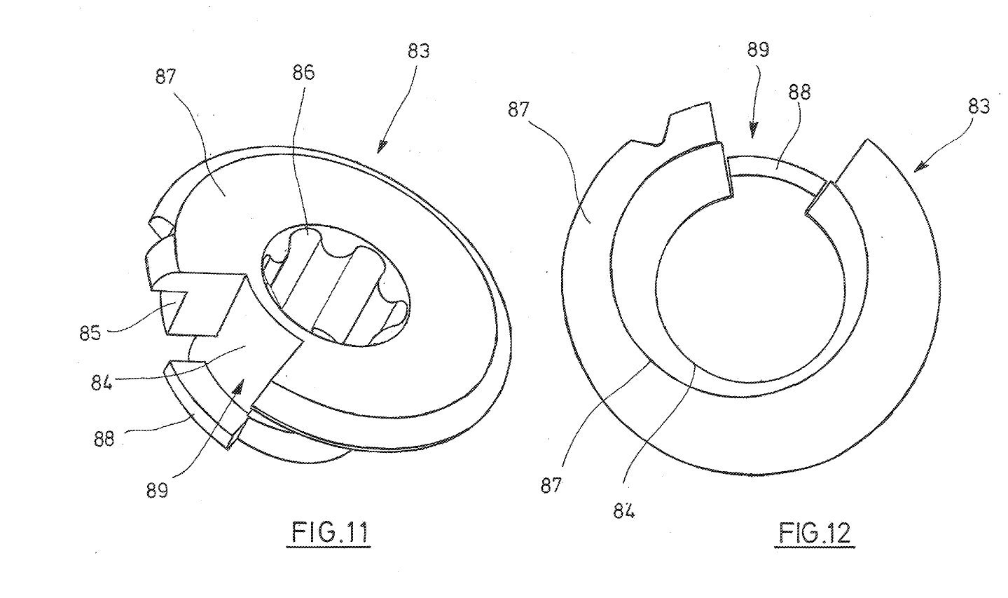

Further, the covering part 41 comprises an eccentric part 83. According to FIGS. 11 and 12, the eccentric part 83 has a shaft 84 on which an eccentric 85 is disposed. The diameter of the eccentric 85 corresponds to the length of the shorter side of the eccentric receptacle 82. At one end of the shaft 84, there is a tool application arrangement 86 (for instance torx, cross recess, hexagon socket or slit), which is accessible from a front side of the shaft 84. On this end, a radially projecting disc 87 is arranged on the shaft. On the other end, the shaft 84 has a radially projecting catch projection in the form of an annular disc segment.

For reasons of manufacture, disc 87 and eccentric 85 have a second recess 89, whose radial limits fall in line with the catch projection 88.

The eccentric part 83 is inserted into the eccentric receptacle 82 and the bearing bore 50 in the axial direction of the bearing bore, so that the disc 87 grips over the second covering part 60. The catch projection 88 is introduced through the first recess 54 on the corner of the cantilever 45, and turned under the bore edge 53. The eccentric 85 is arranged in the region of the eccentric receptacle 82 and of the front recess 51. The catch projection 88 grips below the bore edge 53 and engages into the rear deepening 52.

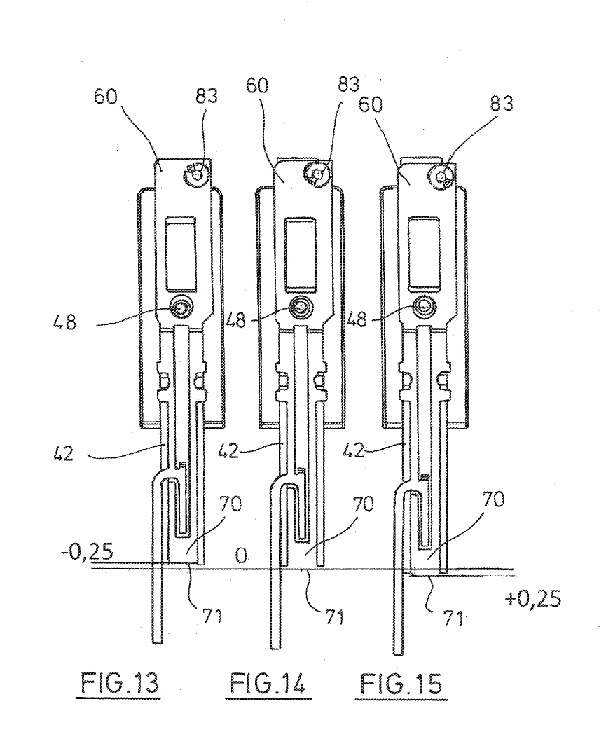

The eccentric part 83 can be rotated by applying a tool on the tool application arrangement 86. In this action, the eccentric 85 displaces the second covering part 60 with respect to the first covering part 42 in the axial direction. The two extreme positions of the second covering part 60 with respect to the first covering part 42 in this displacement are shown in FIGS. 13 and 15, the two positions being remote for +/−0.25 mm from the middle position in FIG. 14.

According to FIGS. 2 to 6, the tooth bar 28 extends through the channel 58 of the first covering part 42. The pawl 39 is threaded on the spring tongue 73 of the second covering part 60 with a guide slot 90 on the lower end. The covering 41 is guided in the housing on the wing parts 46, 47 so as to be movable in the longitudinal direction.

By turning the dial 10, the covering 41 can be displaced in the longitudinal direction. For this purpose, the dial 10 has a central bearing hole 91 and a helical guide curve 92 according to FIG. 16. The dial 10 is rotatably mounted on the bearing hole 91, on an axis on the housing 2, and the pin 48 of the covering 41 engages into the guide curve 92. As a consequence, the covering 41 is displaced along its guiding in the housing 2 when the dial 10 is turned.

A further sensor 93 is associated to the dial 10, which detects the rotational position of the dial 10.

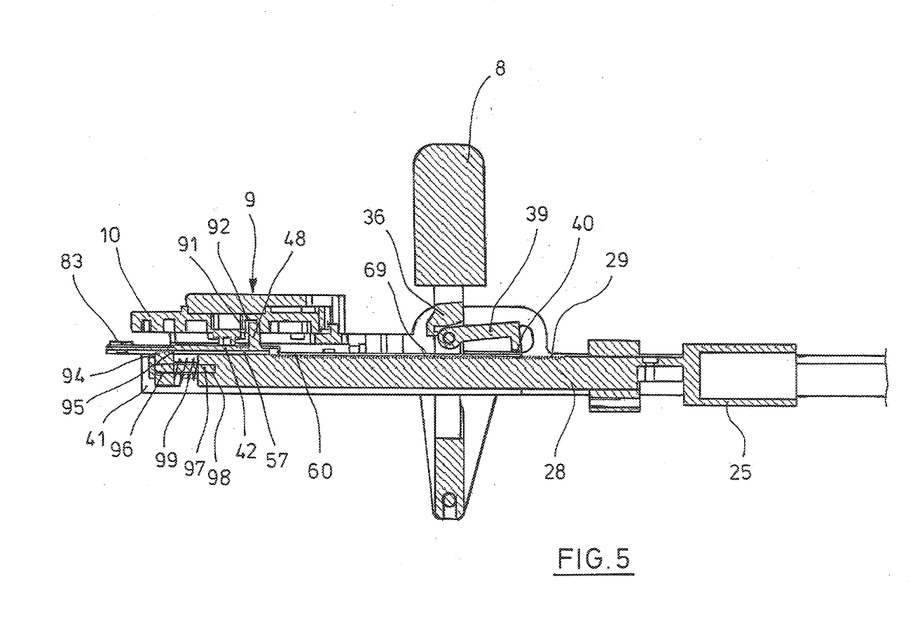

According to FIG. 5, a cam 94 is arranged at the upper end of the tooth bar 28. The cam 94 projects outward from a further longitudinal slot 95 of the tooth bar 28. Below the further longitudinal slot 95, the cam 94 has an axial bore 96. An adjusting screw 97 is screwed across the axial bore 96 into an adjusting thread 98 on the upper end of the tooth bar 28. A helical spring 99 is guided on the adjusting screw 97 and is supported at one end on the screw head of the adjusting screw 97, and at the other end on the upper end of the tooth bar 28, in order to keep the cam 94 in close bearing against the screw head.

When the tooth bar 28 is displaced downward, the cam 94 is moved across the longitudinal groove 57 of the cantilever 45, and it exits from the longitudinal slot 59 of the covering 41 between the reverse angular deflections 64, 65. Finally, the cam hits the projecting angular deflection 69 and pushes it forward together with the spring tongue 73. Through this, the pawl 39, guided on the spring tongue 73, is lifted out of the toothing 29, and a residual stroke lock is realised.

Adjacent to the tooth bar 28, a transmission element 100 for controlling a reverse stroke is arranged in the housing of the pipette. The transmission element 100 has a stripe-shaped transmission portion 101, which is guided parallel to the tooth bar 28 in the housing 2 of the pipette and can be dislocated.

The stripe-shaped transmission portion 101 has a lower end of the transmission element 102, which is situated in the dislocation range of a lower stop 103 which projects from the side of the tooth bar 28 when the transmission element 101 is displaced downward.

Two control arms 104, 105 are connected to the upper end of the stripe-shaped transmission portion 101, which are arranged in parallel to each other in a plane vertical to the plane of projection.

The transmission element 100 can be displaced such that the control arms 104, 105 arrive in the dislocation range of chamfered stop edges on the legs 37, 38 with their upper ends (compare FIGS. 10 to 13).

The transmission element and the component parts co-operating with it are preferably realised like described in the European patent application 120 02 849.3-2113 and in the U.S. provisional application No. 61/636,977, whose content is herewith incorporated into the present application by reference.

Further, a circuit board 106 with an electronic assembly 107 is arranged in the upper half of the housing 2. Here is also situated a power supply in the form of batteries or accumulators 108. The electronic assembly 107 is wired to the ring sensor 22, the further sensor 93 for detecting the rotational position of the dial 10 and the display 9. The electronic assembly is further connected to the accumulator 108.

The electronic assembly 107 determines the corresponding syringe size from the data delivered by the ring sensor 22, and from the setting of the dial 10 the corresponding step size. From these, it calculates the set dispensing volume and displays it on the displays 9.

In the utilisation of the pipette 1, a syringe 3 with a syringe size selected by the user is detachably connected to the pipette 1 at first, by plugging it into the fixture 20 with the first fastening portion 16, and into the fixture 24 with the second fastening portion 19, so that the flange 17 is grasped by the first gripping levers 23, and the fastening portion 19 by the second gripping levers 27. This situation is shown in FIG. 2.

The ring sensor 22 gauges the encoding on the flange 17 of the syringe 3. By way of the signals delivered by the ring sensor 22, the electronic assembly 107 detects that a syringe 3 is plugged in, and switches on the display 9. By way of the signals delivered by the ring sensor 22 and by the sensor 93, the electronic assembly 107 determines the set dispensing volume and indicates it on the display 9. If so, the user changes the setting of the dispensing volume by means of the dial 10, and the changed dispensing volume is indicated by the display 9.

In order to draw up liquid through the hole 14 of the syringe 3, the draw-up lever 5 is pushed upward from the position of FIG. 2.

At the end of the draw-up movement, the lower stop 103 takes the transmission element 100 along.

Before the set metering volume can be delivered in steps, a reverse stroke must be performed. This occurs by actuating the actuation button 8. In this action, the legs 37, 38 hit the control arms 104, 105 and dislocate the transmission element 100 downward. Via the lower stop 103, the transmission element 100 takes the tooth bar 28 along. The clearance is removed from the system by this reverse stroke.

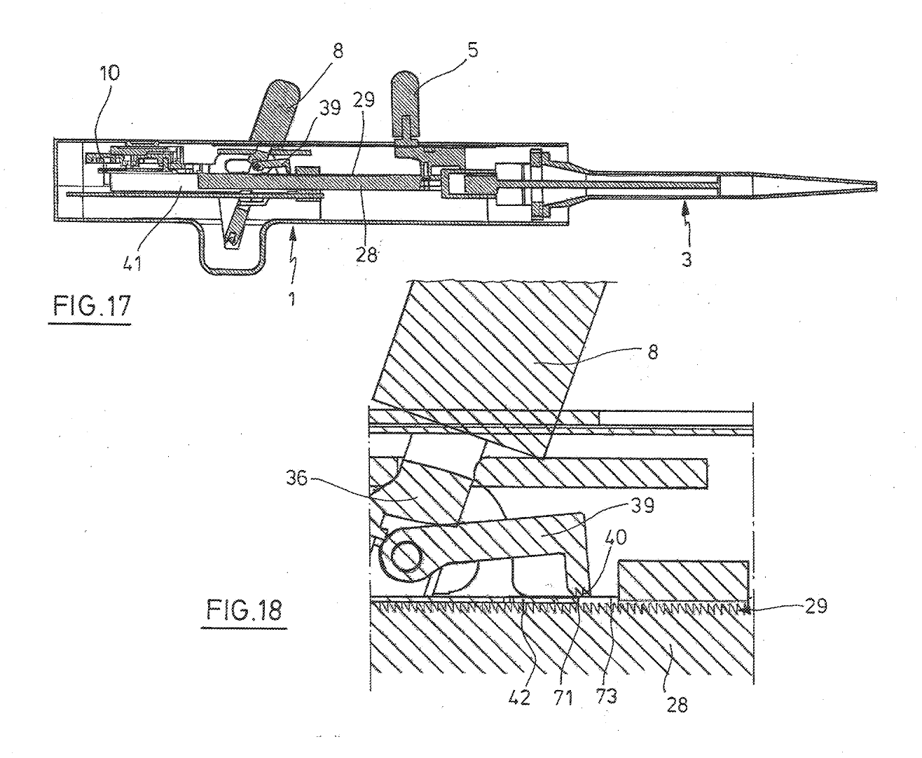

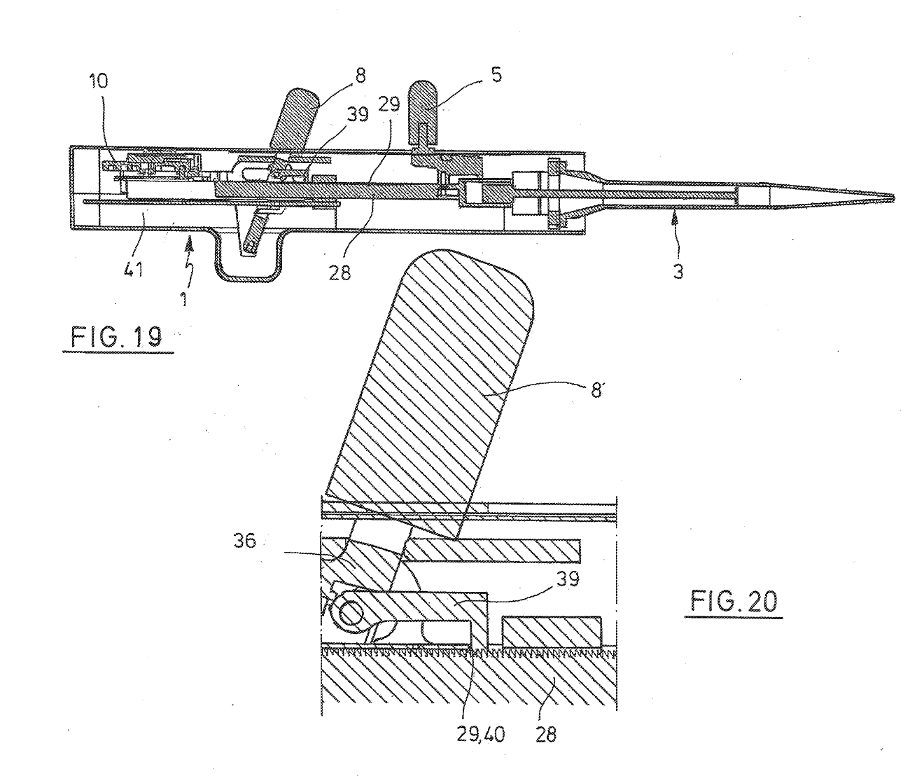

Thereafter, the drawn-up amount of liquid can be delivered in small steps by pushing the actuation button 8 repeatedly downward against the action of the spring equipment. In this, the further spring equipment pushes the pawl 39 with the pawl tooth 40 against the covering, until the pawl tooth 40 reaches the lower end of the withholding surface 70. This situation is shown in FIGS. 17 and 18. After passing over the incident edge 71, the pawl 39 falls into the toothing 29 of the tooth bar 28 with the pawl tooth 40, and takes the tooth bar 28 somewhat along in the further downward swinging of the metering lever 36. This situation is shown in FIGS. 19 and 20. When the metering lever 36 is swung until it arrives on a lower stop, the dislocation of the tooth bar 28 depends on a position of the covering 41 set by means of the dial 10. After unloading the actuation button 8, it is pushed upward by the spring equipment, and a further metering step can be performed.

Dispensing without having to refill the syringe 3 is possible for so long until the residual amount of liquid remained in the syringe 3 is smaller than the set metering amount. Then, a residual stroke lock provides that the pawl tooth 40 can no more fall into the toothing 29 in that the cam 94 actuates the spring tongue 73 which swings the pawl 39 away from the tooth bar.

Any residual liquid in the syringe 3 can be discharged by dislocating the draw-up lever 5 downward. Thereafter, the syringe 3 can be separated from the pipette 1. In order to do this, the user actuates the first gripping levers 23, which act via projections on the inner side on the second gripping levers 27, like described in the documents EP 0 656 229 B1 and U.S. Pat. No. 5,620,660 A, the entire contents of which is incorporated herein by reference.

Instead of immediately manually operable gripping levers 23, 27, a pipette of the present invention preferably comprises first and second means for detachably holding the syringe, which are made such like described in the documents EP 2 033 712 A1 and US 2009/139351 A1, the entire contents of which is incorporated herein by reference, whose content is herewith incorporated into the present application by reference. In the pipette according to the two aforementioned documents, the syringe is detached from the pipette after emptying by a further actuation of the metering lever. For this purpose, the pipette has a gear system which is controlled by the metering lever and acts on the first and second means for holding the syringe, in order to detach the syringe from the pipette. According to one embodiment of this pipette, the first and second means for detachably holding are realised as gripping levers, which are integrated into the housing and cannot be actuated immediately from the outside.

According to FIGS. 19 and 20, the pawl 39 falls optimally into the toothing, i.e. each pawl tooth engages exactly in a valley between two teeth of the toothing.

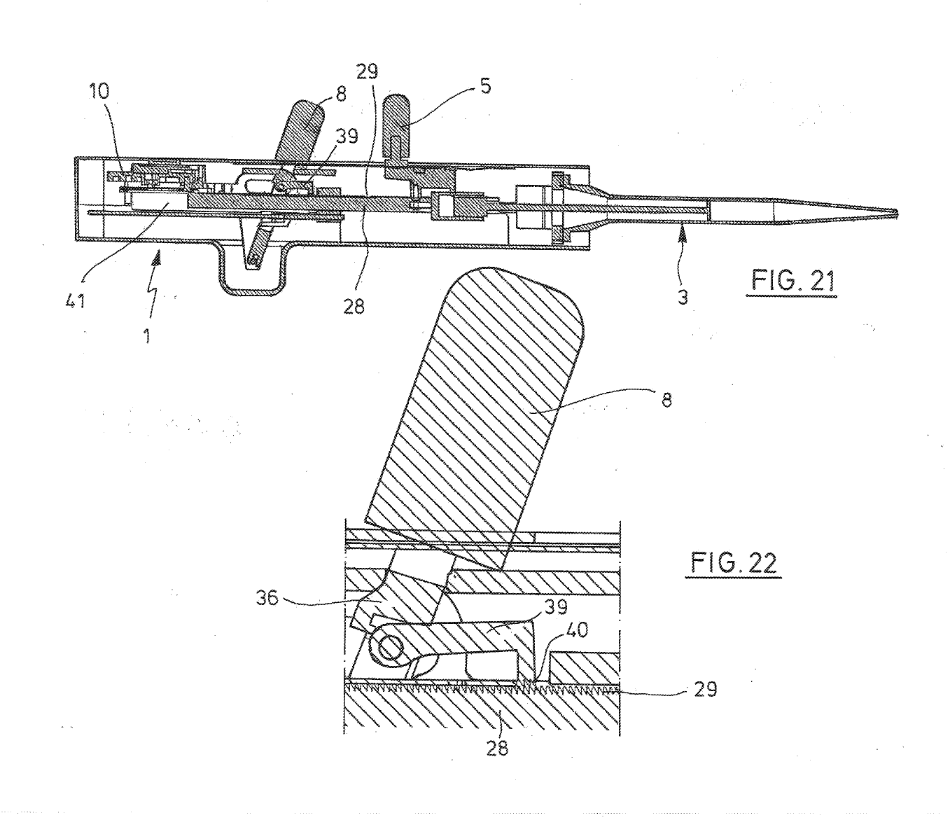

According to FIGS. 21 and 22, pawl teeth 40 are unfavourably directed to the toothing 29, so that they fall into the wrong position or can slip over the toothing 29 when the metering lever 36 is swung. By adjusting the covering 41 in the manner described by way of FIGS. 13 to 15, this can be overcome, so that the pawl 39 falls into the toothing 29 like shown in FIGS. 18 and 19. The adjustment is possible through a hole in the housing 2 or after taking off the front half of the housing by applying a tool on the eccentric part 83 (compare FIG. 3).

While this invention may be embodied in many different forms, there are described in detail herein a specific preferred embodiment of the invention. This description is an exemplification of the principles of the invention and is not intended to limit the invention to the particular embodiment illustrated.

### LIST OF REFERENCE SIGNS

1 pipette
2 housing
3 syringe
4 slit
5 draw-up lever
6 slit
7 slit
8 actuation button
9 display
10 dial
11 cylinder
12 piston
13 conical portion
14 hole
15 cylindrical portion
16 fastening portion
17 flange
18 piston rod
19 second fastening portion
20 first fixture
21 first opening
22 ring sensor
23 first gripping lever
24 second fixture
25 fixture body
26 second opening
27 second gripping lever
28 tooth bar
29 toothing
30 draw-up lever mount
31 draw-up lever carrier
32 sliding board
33 post
34 hinge bearing
35 bulge
36 metering lever
37 leg
38 leg
39 pawl
40 pawl tooth
41 covering
42 first covering part
43 side parts
44 side parts
45 cantilever
46 wing part
47 wing part
48 pin
49 slot nut
50 bearing bore
51 front deepening
52 rear deepening
53 bore edge
54 first recess
55 guide hook
56 guide hook
57 longitudinal groove
58 channel
59 longitudinal slot
60 second covering part
61 head portion
62 centre portion
63 centre portion
64 reverse angular deflection
65 reverse angular deflection
66 foot portion
67 first connection portion
68 central stripe portion
69 projecting angular deflection
70 withholding surface
71 incident edge
72 second connection portion
73 spring tongue
74 hole
75 punching
76 tongue
76 tongue
77 tongue
78 tongue
80 free space
81 free space
82 eccentric receptacle
83 eccentric part
84 shaft
85 eccentric
86 tool application arrangement
87 disc
88 catch projection
89 second recess
90 guide slots
91 bearing hole
92 guide curve
93 further sensor
94 cam
95 further longitudinal slot
96 axial bore
97 adjusting screw
98 adjusting thread
99 helical spring
100 transmission element
101 transmission portion
102 lower end of transmission element
103 lower stop
104 control arm
105 control arm
106 circuit board
107 electronics assembly
108 accumulator

What is claimed is:

1. A pipette for actuating a syringe, with
a bar-shaped housing (2),
a first fixture (20) with a first opening (21) at the lower end of the housing (2) for putting in a first fastening portion (16) on the upper edge of a cylinder (11) of the syringe (3)
a fixture body (25) with a second fixture (24) and a second opening (26) on the lower end of the housing (2), for putting in a second fastening portion (19) on a piston (12) of the syringe (3),
first means for detachably holding (23) the first fastening portion (16) in the first fixture (20),
second means for detachably holding (27) the second fastening portion (19) in the second fixture (24),
first means for displacing (5) the fixture body (25) in the housing (2) away from the first fixture (20),
second means for displacing (28, 36, 39) the fixture body (25) towards the first fixture (20) in steps with a step size corresponding to the liquid volumes to be ejected by the syringe (3) in the steps,
an actuating element (36) for performing single steps, which can be actuated from the outside of the housing (2)
a tooth bar (28) connected to the fixture (25) with a toothing (29) in the housing (2),
a pawl (39), pivotally mounted on the actuating element (36) in the housing (2), which comes into engagement with the toothing (29) of the tooth bar (28) when the actuating element (36) is displaced downward and takes the tooth bar (28) along, and comes out of engagement with the toothing (29) when the actuating element (36) is displaced upward,
an adjusting element (10), adjustable from the outside of the housing (2), for adjusting the step size of the steps,
a covering (41), movably arranged on the tooth bar (28) at the side of the pawl (39) and having a withholding surface (70) facing the pawl (39), for withholding the pawl (39) from engagement into the toothing (29), and having an incident edge (71) at the lower end, below of which the toothing (29) is exposed for the engagement by the pawl (39),
a coupling element (48) arranged on the covering (41), which is coupled to the adjusting element (10) in order to transfer a setting of the adjusting element (10) to the covering (41),
wherein the covering (41) comprises a first covering part (42) on which the coupling element (48) is arranged, and a second covering part (60) on which the incident edge (71) is formed, whose relative position to each other in the longitudinal direction of the tooth bar (28) is adjustable, and
means for positioning (83) arranged on the covering (41), which fix the first and the second covering part (42, 60) in an adjusted position relative to each other.

2. The pipette according to claim 1, wherein the first covering part (42) is arranged on the tooth bar (28), and the second covering part (60) is held on the first covering part (42).

3. A pipette according to claim 1, wherein the covering (41) has means for axially guiding (49, 55, 56) the second covering part (60) with respect to the first covering part (42) parallel to the tooth bar (28).

4. The pipette according to claim 3, wherein the means for axially guiding (55, 56) comprise guiding structures of the first covering part (42) extending over the second covering part (60) at the edge thereof.

5. A pipette according to claim 1, wherein the first covering part (42) is a hollow body guided on the tooth bar (28), and/or the second covering part (60) is stripe-shaped.

6. A pipette according to claim 1, wherein the second covering part (60) is a thin-walled piece of metal.

7. A pipette according to claim 1, wherein the tooth bar (28) comprises a projecting cam (94) on the side facing the covering, the first covering part (42) has a longitudinal slot (95) out of which the cam (94) exits when the fixture body (25) is displaced towards the first fixture (20), the second covering part (60) has an angular deflection (69) and a spring tongue (73) connected thereto which the cam (94) hits when the displacement of the fixture body (25) towards the first fixture is ended, whereby the spring tongue (73) is deflected and the pawl (39) is withheld from further engagement into the toothing (29) of the tooth bar (28) by the spring tongue (73).

8. The pipette according to claim 7, wherein the cam (94) projects out of the tooth bar (28) through a further longitudinal slot (95) at the side of the covering (41) and has an axial bore (96), an adjusting screw (97) is screwed across the bore (96) into an adjusting thread (98) at the upper end of the tooth bar (28) and a spring element (99) is arranged between the upper end of the tooth bar (28) and the cam (94).

9. A pipette according to claim 1, wherein the means for positioning (83) comprise means for adjusting the position of the second covering part (60) relative to the first covering part (42) in the longitudinal direction of the tooth bar (28).

10. A pipette according to claim 1, wherein the means for positioning (83) comprise an eccentric part with a shaft (84), an eccentric (85) on the shaft (84) and a tool application arrangement (86) at one end of the shaft (84), wherein the shaft is (84) bearing mounted at one end in a bearing bore (50) of the first covering part (42) or of the second covering part (60), and the eccentric (85) engages into an eccentric receptacle (82) of the second covering part (60) or the first covering part (42), so that the second covering part (60) can be moved relative to the first covering part (42) via the eccentric (85) by rotating the shaft (84).

11. The pipette according to claim 9, wherein a disc (87) is arranged at one end of the shaft (84), which bears against the outer side of the second covering part (60) or the first covering part (42), and/or wherein the shaft (84) has a catch projection (88) at one end which grips behind a bore edge (53) of the bearing bore (50) of the first covering part (42) or of the second covering part (60).

12. A pipette according to claim 9, wherein the means for positioning (83) permit to adjust the position of the second covering part (60) with respect to the first covering part (42) in an adjustment range which corresponds to the distance of two valleys on different sides of a tooth of the toothing.

13. A pipette according to claim 9, wherein the means for positioning (83) permit to adjust the position of the second covering part (60) with respect to the first covering part (42) in an adjustment range which is +/−0.25 mm.

14. A pipette according to claim 1, wherein the coupling element (48) is a pin protruding from the first covering part (42) and the adjusting element (10) comprises a guide curve (92) at the bottom side into which the pin engages, so that the guide curve (92) displaces the pin in the axial direction of the tooth bar (28) when the adjusting element (10) is shifted.

15. A pipette according to claim 1, wherein the means for positioning (83) are arranged such on the covering (41) that they are not covered up by the adjusting element (10) in at least one position of the adjusting element (10).

16. A pipette according to claim 1, wherein the means for positioning (83) are arranged at the upper end of the covering (41).

17. A pipette according to claim 1, wherein the first covering part (42) is made of plastics and/or the second covering part (60) of sheet metal.
